(19) United States
(12) Patent Application Publication
(10) Pub. No.: US 2010/0214118 A1
(43) Pub. Date: Aug. 26, 2010

(54) SYSTEM AND METHOD FOR TRACKING A PERSON

(76) Inventors: Paul Losee, Layton, UT (US); Joseph W. Blankshain, Scottsdale, AZ (US); Lance King, Midway, UT (US); Daniel C. Maxwell, West Valley City, UT (US); William Kurt Dobson, Midvale, UT (US); Kent Garland, Salt Lake City, UT (US); Fred Gallander, Park City, UT (US)

Correspondence Address: THORPE NORTH & WESTERN, LLP., P.O. Box 1219, SANDY, UT, 84091-1219, US

(21) Appl. No.: 12/709,003

(22) Filed: Feb. 19, 2010

Related U.S. Application Data
(60) Provisional application No. 61/154,321, filed on Feb. 20, 2009.

(51) Int. Cl. G08B 5/22

(52) U.S. Cl. 340/825.49

(57) ABSTRACT

A system and method for tracking a person using a deduced reckoning device is disclosed. The method includes the operation of selecting an initial location of the person. The person's movement along a path is then monitored using directional sensors, including a digital magnetic compass, at least one accelerometer, at least one magnetometer, at least one gyroscope, and an altimeter. The person's changing location is recorded based on a change in outputs of the directional sensors that occur during the person's movement. The person's changing location is transmitted to a command and control center. The person's changing location is then displayed on a graphical user interface at the command and control center.

### CROSS-REFERENCE TO RELATED APPLICATIONS AND CLAIM OF PRIORITY

Priority of U.S. Provisional patent application Ser. No. 61/154,321 filed on Feb. 20, 2009 is claimed.

### BACKGROUND

The ability to accurately track and locate personnel can be critical to a mission's success or failure. Mission commanders leading an emergency response team are often limited in their ability to determine where critical assets are located, including human assets that have been dispatched into the field. Certain technologies have been developed that can enable tracking of assets. These technologies are typically reliant on continuous radio frequency communications. For example, global positioning satellite (GPS) systems and other types of triangulation systems can be used to determine a location of an asset based on the timing of radio signals received at the asset location. The ability to track assets using radio frequency signals has greatly improved a commander's ability to track and locate desired assets.

However, in many types of emergencies, radio frequency communications can be spotty. Tornadoes and hurricanes often destroy power and communications infrastructure, thereby reducing the ability to use land based communications and radio frequency triangulation systems. Buildings and storms can impede radio frequency signals to the point where GPS systems can be useless. Thus, over reliance on tracking devices that rely on continuous radio frequency communications can actually impede progress in an emergency response when the tracking devices cease to function properly due to the environment of the emergency location.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a block diagram of an example deduced reckoning system in accordance with an embodiment of the present invention;

FIG. 2 is an illustration of an example graphical user interface used to display positional information of human assets in accordance with an embodiment of the present invention; and

FIG. 3 is a flow chart depicting a method for tracking a person using a deduced reckoning device in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of materials, fasteners, sizes, lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The ability to accurately track human assets involved in emergency missions and other first response scenarios can significantly enhance a mission leader's ability to make decisions that will increase the probability of success of the mission. However, the leader's decisions are only as good as the data provided. If radio frequency tracking equipment that is relied on to track human assets provides inaccurate data, or worse, no data at all, the reliance on the tracking equipment can have a negative effect on the outcome of the mission.

As previously discussed, asset tracking in emergency situations using radio frequency tracking equipment may not be reliable, especially in disaster situations such as tornadoes, flooding, hurricanes, and war time situations. The destruction of land based infrastructure may reduce or eliminate signals needed to allow the tracking equipment to work. For example, the tracking equipment may be reliant on land based cellular telephone transmitters to provide tracking of assets based on triangulation of radio frequency signals. The cellular telephone transmitters can be destroyed or disrupted by power failures in natural disasters, thereby reducing their reliance. GPS systems can prove more robust in a disaster area due to their use of space based satellite signals for use in triangulation. However, since the GPS signals are sent from satellites located thousands of miles away, the signal power received at a GPS receiver is quite low, thereby providing a significant probability that the signal may be lost in urban areas, within buildings, during a severe storm, and so forth.

Even a brief disruption can be unacceptable in certain situations. For example, in a high rise building fire it can be critical to know where each emergency responder is located in the event that the responders need to be evacuated. Many of the responders may be positioned in locations within the building that are not amenable to receiving and transmitting radio frequency signals. Thus, positional awareness of each emergency responder's location cannot be accomplished by relying on radio frequency communications alone.

In order to increase the reliability of asset tracking in first responder, emergency, and security situations, one or more backup systems can be used to supplement information obtained through radio frequency tracking. More specifically, deduced reckoning techniques can be used to supplement the radio frequency tracking of human assets to provide substantially accurate positional information to enable mission commanders to make more informed decisions in time critical situations.

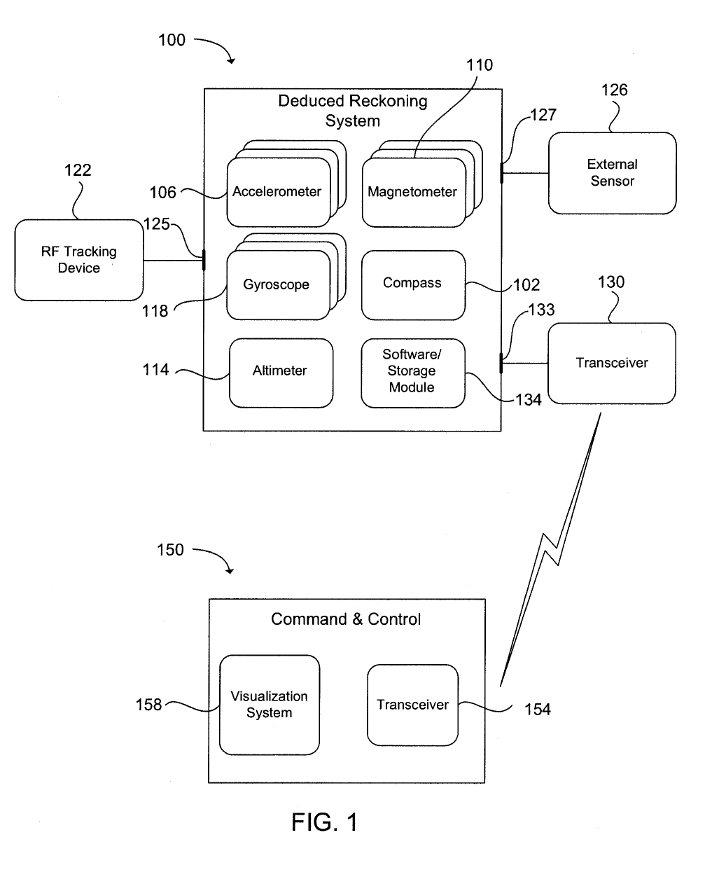

FIG. 1 provides an exemplary block diagram, in accordance with one embodiment of the present invention, of a deduced reckoning system 100 that can be used to obtain additional information to track the movement and location of a human asset. This information can be used on its own, or combined with other information such as radio frequency tracking information to provide a substantially accurate estimate of a human asset's position and location.

Due to a human's unique motion while traveling, various types of sensors can be used to provide a substantially accurate record of a person's movement from a selected initialization point. A deduced reckoning position is derived by monitoring a user's walking motion and a direction of travel using directional sensors. For example, the deduced reckoning system 100 can include directional sensors including a digital magnetic compass 102 that can be used to determine a direction of the person's movement. One or more accelerometers 106 can be used to measure a person's stride and the number of steps that are taken. At least one magnetometer 110 can be used to reduce the effect that external magnetic fields or ferromagnetic materials near the system can have on the output of the compass. An altimeter 114 such as a barometric altimeter can be used to measure altitude, which can be critical in locating a person in a building, on a mountain, or another type of a three dimensional environment. One or more gyroscopes 118 can also be used to increase a positional accuracy of the deduced reckoning system. In one embodiment, a separate gyroscope, magnetometer, and accelerometer can be positioned in three mutually orthogonal axes to enable precise measurements of a person's movement in each of these three directions.

An external radio frequency (RF) tracking device 122, such as a GPS receiver, can be connected to the deduced reckoning system 100 via a tracking device connector 125. The tracking device connector can be an analog or digital connector, including a serial connector or a parallel connector. Connector types that can be used for the tracking device connector include an RS232 connector, a USB connector, an HDMI connector, an RF connector, and the like. Positional information from the RF tracking device can be used in combination with the information obtained from each of the directional sensors within the system to provide a substantially accurate record of a person's position and movement. The RF tracking device 122 can be used to provide a relatively accurate record of the user's location.

The information from the deduced reckoning system 100 can enhance the accuracy of the RF tracking device 122 and provide a backup in the event that the RF tracking device becomes inoperable due to radio frequency interference or signal loss of the reference signals used to calculate positional information. The use of an external RF tracking device, such as a GPS receiver, in conjunction with the deduced reckoning system enables the deduced reckoning system to be used on its own without the use of an external RF tracking device, in conjunction with a commercially available GPS receiver or with a military grade GPS receiver, or with another type of RF tracking device such as a triangulation system using terrestrial signal sources such as cell phone towers or other fixed locations of RF signals.

Additional external sensor(s) 126 can also be connected to the deduced reckoning system 100. In one embodiment, the external sensor can comprise one or more environmental sensors 126 that can be coupled to the deduced reckoning system via at least one external sensor connector 127. The external sensor connector can be a digital or analog connector such as a USB connector, an HDMI connector, an RS232 connector, a radio frequency connector, and the like. Multiple external sensor connectors 127, such as USB connectors, may be included in the deduced reckoning system to enable multiple external sensors to be connected. Alternatively, a multiple connection expander, such as a USB expansion hub, can be connected to the external sensor connector to enable multiple USB connectable devices to be connected to a single USB connector included in the deduced reckoning system. Additional electronic means may also be used, such as multiplexing signals from multiple external sensors onto a single line connected to the external sensor connector 127.

In one embodiment, environmental sensors can be connected to the deduced reckoning system through the external sensor connector(s) 127. The environmental sensors can be used to provide additional information to a mission leader. For example, the environmental sensor can be a thermistor or other type of heat sensor that can be used to determine a temperature at a position of each person in the field using the deduced reckoning system. For certain types of systems, multiple thermistors may be used to provide directional temperature readings. The knowledge of the temperature at a selected location can be useful at command and control centers used to direct emergency responders to a fire, especially in a large building. For example, if an emergency responder's thermistor located on a left side of the responder's body were substantially hotter than the thermistor on the right side of the responder's body, it can be deduced that the fire is to the left of the emergency responder. The responder may be unaware of the temperature difference due to protective clothing that is worn. A field commander can view the information provided by the deduced reckoning system and provide the information to the fire fighter to guide him to the proper location.

Other types of environmental sensors can also be used, such as oxygen sensors that can be used to determine a source of the fire based on the amount of oxygen present. The oxygen level may decrease as the emergency responder nears a center of the fire. The field commander can view the oxygen content, as represented on a graphical user interface, at the location of each emergency responder and gain a better understanding of the location and intensity of the fire. Other environmental sensors can be used to provide additional information needed for specific missions, as can be appreciated.

Additional environmental sensors 126 can include sensors for barometric pressure, humidity, ambient light, and so forth. Additionally, the characteristics of the air can be measured and reported using environmental sensors, such as gas content, gas concentrations, particulate identification and concentration, and so forth. Moreover, health status sensors can also be connected to the external sensor connector. The health status sensors can be used to monitor the health of the first responders. The health sensors can include the heart rate, blood pressure, temperature, respiratory rate, electro-dermal activity, blood pressure, speech, and so forth.

Selected sensors can be used based on the needs of the mission. The information can be used to predict performance and safety outcomes for the first responders in near real time. For example, if first responders came upon a gas, toxin or other type of chemical or biohazard, the location and path taken by the first responder can be reported immediately. A mission commander can use the information to identify where the hazardous material is located to enable educated decisions to be made with regards to potential containment of the hazard while minimizing human contact with the hazardous area.

In one embodiment, an external transceiver 130 can be coupled to the deduced reckoning system 100 through an external transceiver connector 133. The transceiver can be connected to the deduced reckoning system via the external transceiver connector. The external transceiver connector can be a connector such as a serial connector, a parallel connector, a USB connector, an HDMI connector, an RS232 connector, an RF connector, and the like. The external transceiver is used to transmit data collected from the various sensors located in the deduced reckoning system and data collected from the external sensors 126 that can be connected to the deduced reckoning system.

The ability to connect the external transceiver 130 to the deduced reckoning system 100 via the transceiver connector 133 enables the deduced reckoning system to be used in a broad range of applications. Different first responders may use different types of communications systems. Data from the deduced reckoning system may be transmitted using a desired type of external transceiver to communicate the data to a command and control center 150 transceiver 154. For example, in one embodiment data can be transmitted on a sub-channel of a transceiver such as a Motorola radio designed for use by first responders.

In addition, the external transceiver 130 can output a signal at a relatively high power to increase the likelihood that the data transmitted by the deduced reckoning system is received at the command and control center 150. For example, the Motorola radio referenced in the example above can transmit a signal with greater than one watt of power, millions of times greater than the strength of a GPS signal. The relatively high output power of the external transceiver 130 enables radio frequency communication between the external transceiver and the command and control center 150 to be much more robust than a GPS receiver, thereby enabling communication to occur in buildings and other structures that may prohibit the reception of GPS signals. Thus, even though an RF tracking device 122, such as a GPS receiver that is connected to the deduced reckoning device 100, may not be able to receive a GPS signal, the transceiver 130 may still be capable of communicating to the command and control center 150 transceiver 154.

Various software algorithms in the deduced reckoning system 100 of FIG. 1 can be performed to track and analyze the data output from each of these sensors to provide a substantially accurate estimate of a person's movement. The algorithms can be performed in a software/storage module 134 used to compute and analyze data output from the instruments in the deduced reckoning system. The software/storage module can include several gigabytes of digital storage coupled to computer processors used for performing calculations. The digital storage is typically solid state type memory, though rotational recording means, such as a magnetic hard drive or optical disc may also be used. The computer processor may be a general computer processor, a digital signal processor, an application specific integrated circuit, a field programmable gate array, and the like.

Various algorithms for motion classification, digital filtering, and adaptive algorithms can be performed in the software/storage module to maximize the accuracy of measurements made using the deduced reckoning system 100. For example, some positional and path measurements of first responders may be made under difficult conditions, such as varying stride length due to debris. The use of digital filtering and adaptive algorithms enables the first responder's path to be accurately determined despite the difficulties.

It is also possible to transmit the raw data provided by the directional sensors in the deduced reckoning system 100 to enable the data to be processed at a later date or using different algorithms than are available within the software/storage module 134. Moreover, processing of raw data at a location external to the deduced reckoning system can significantly reduce power consumption, thereby extending battery length and allowing the deduced reckoning system to operate for a greater period of time.

In one embodiment, a person's path and positional information for a predetermined period, such as 60 minutes, can be stored within the software/storage module 134 in the deduced reckoning system 100. The system can output the person's path and positional information via the external transceiver 130 to the command and control center 150 at a desired frequency, such as once every 30 seconds.

In one embodiment, the command and control center 150 can communicate an acknowledgement signal back to the deduced reckoning system 100 confirming that the positional information was received. If no acknowledgement signal is received at the external transceiver 130 by the next transmit period, then the previous positional information plus the current positional information is transmitted. The retransmission of the data from the deduced reckoning system can continue until an acknowledgment is received by the transceiver 130 or for a set period, such as 60 minutes. The actual recording length depends upon the needs of the system and the amount of digital storage available within the system. Hundreds of hours of data can be stored as needed in the digital storage of the software/storage module 134.

The ability to retransmit data that was not received at the command and control center 150 enables emergency responders to move about urban areas, buildings and other areas where there are potential radio frequency interference problems without a fear that their position will become unknown. The probability that a signal containing the emergency responder's path and positional information will be received is greatly increased as the responders move about. In addition, transceiver repeaters can be used to boost a signal at an emergency location. Even though signals from first responders may not be received initially, the repeaters can be setup to boost the signal of the transceiver, thereby enabling the signal to be received and the path and positional information to be received. Moreover, the power output of the signals transmitted by the external transceiver 130 can be sufficient to provide a good probability that the data transmitted by the transceiver is received at the command and control center transceiver 154, as previously discussed.

In one embodiment, the hardware and software used to provide a deduced reckoning of a person's movement can be provided by a DRM 4000 system built by Honeywell. The module can be used to incorporate the hardware and software in a relatively small form factor that can be easily worn on a person's body. The use of miniaturized electronics, including micro-electro-mechanical system (MEMS) gyroscopes and accelerometers enables the system to be enclosed without the need for external directional sensors such as accelerometer sensors attached to a person's legs or feet.

Other types of deduced reckoning modules may also be used, such as the Tyco A1029, the u-blox LEA-4R, the Trimble 55000-80, and other modules that incorporate the tracking hardware and software needed to accurately determine a person's movement within a desired range. In one embodiment, the deduced reckoning module can be accurate to within 2% of the distance a person has traveled. In another embodiment, accuracy to within 5% may be sufficient. The desired accuracy depends on the type of situation the deduced reckoning module is used for. For example, if used in high rise buildings in a dense urban environment, a greater accuracy may be needed to locate human assets within the high rise building. However, in outdoor environments, such as a disaster area after a flood, earthquake, or hurricane, modules with a lower accuracy can provide sufficient information for a field commander to make accurate decisions. Similarly, the barometric altimeter can be selected to provide a desired level of accuracy. In one embodiment, a change in height can be determined within +/−0.75 meters. This enables emergency responders to be located on a specific floor of a building.

The deduced reckoning system 100 enables tracking of personnel. However, many potential customers have needs that extend beyond simple personnel tracking. Near real time monitoring and the ability to obtain an intelligent understanding of a human asset being tracked and the environment in which that human asset is being tracked in enables superior decision making by those in charge of leading and directing the human asset.

Accordingly, the path and positional information of emergency responders or other types of human assets can be transmitted through the external transceiver connector to the transceiver 130 and received at the command and control center 150 transceiver 154. The data can be communicated to a visualization system 158. While the visualization system is shown as being in the same location as the transceiver 154, it is possible that the data received at the transceiver can be communicated, via a wired or wireless connection, to a separate location where the visualization system 158 can be located

The visualization system can be used to display a graphical user interface that can display a responder's path, position, health, environmental data, and so forth, in near real time. The visualization system can be used to display a simple two dimensional image that enables a user such as a supervisor or other type of mission controller to be aware of the location of all of the human assets. The location of the human assets can be tracked to enable the controller to optimize the distribution of the assets. In addition, the human assets can be quickly recalled or rescued in the case of an emergency. The use of a three dimensional view in the visualization system can provide more visual awareness that increases the ability to determine the locations of assets in the field.

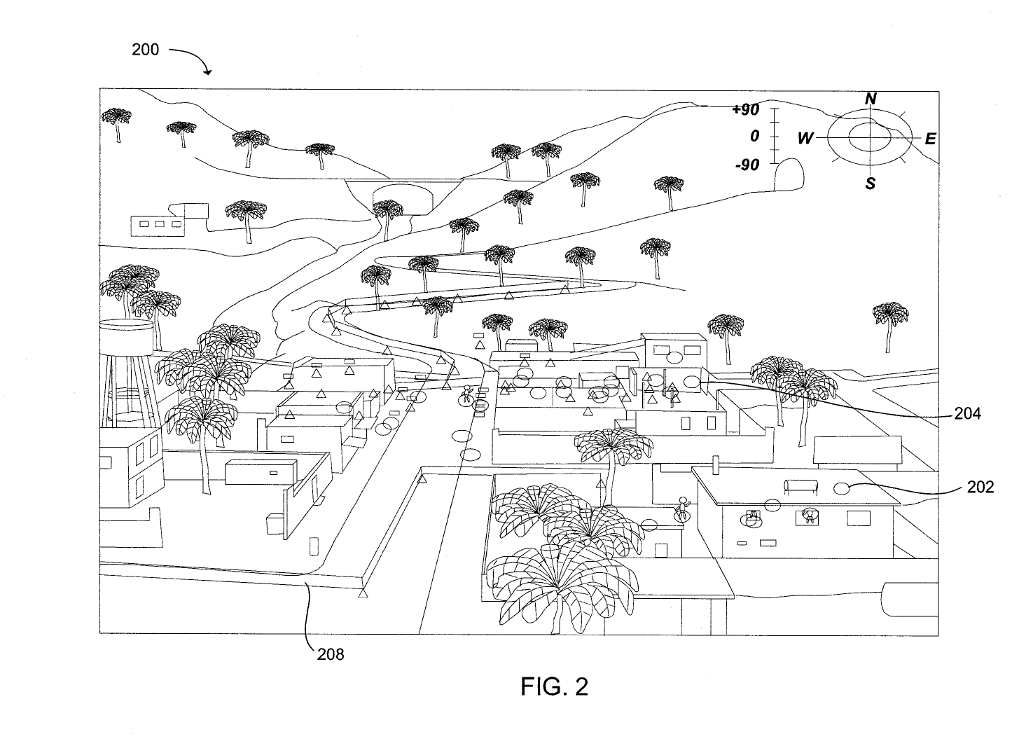

FIG. 2 provides an illustration of one exemplary embodiment of a three dimensional graphical user interface (GUI) 200 for use with the visualization system 158 depicted in FIG. 1. Alternatively, a two dimensional representation may be used when appropriate. The GUI can display a rendering of a mission location. Positional information can be received 154 at the command and control center 150 from a plurality of human assets located in the field using deduced reckoning systems 100. The command and control center may be located near the location where the assets have been distributed. Alternatively, the positional information can be transmitted via cell towers, satellite communications, or other types of wireless and/or wired communication systems to command and control centers that are located hundreds or thousands of miles away from the mission site.

The graphical user interface 200 can allow a user to view a desired location at which one or more human assets have been allocated. The view may be of an outdoor region, as shown in FIG. 2. Alternatively, a three dimensional rendering of the exterior and/or interior of a building may be displayed. The human assets that have been allocated to that area can be identified on the GUI display. Selected icons 202, 204 can be used to display different groupings of people that have been sent into the field. Additionally, different icons can be used to show the status of members of the group. For example, a person that has been sent into the field and becomes hurt or injured can press a button that will immediately display an injured icon on the GUI, along with his or her current position.

In another embodiment, avatars can be displayed on the graphical user interface 200 rather than merely displaying simple icons such as circles or triangles to represent persons in the field, as shown in FIG. 2. The use of avatars to represent persons in the field can provide additional information that enables better decision making. A field commander can more quickly and accurately understand the locations of selected persons in the field. For example, the field commander may want to use a particular person with a specific skill. The commander can quickly locate the person by visually discerning the location of the person's avatar on the graphical user interface.

In addition, avatars can display more complex information. Different colors or images of the avatar can be used to convey health and environmental status. Also, the displayed avatar can animated to represent the actions of the associated person. When the person is running, the avatar can be shown running. If the person is stooping or crawling, the avatar can be shown in a similar status. A field commander can quickly discern certain conditions in the field by viewing the animated actions of the associated avatars. For example, if all of the avatars located on a specific floor of a burning building are suddenly shown stooping and crawling, the field commander can quickly discern that there may be a flare up on that floor, and take immediate action based on the display of the avatars, thereby reducing the time needed to react and potentially saving lives.

The GUI 200 can also be used to display a path 208 of a selected asset. A user of the GUI can turn the displayed path 208 of the selected asset on and off as needed to eliminate cluttering the GUI when the asset's path information is not needed.

The image displayed in the GUI for a selected location may be obtained from a database that includes a three dimensional rendering of a desired location, such as a building, a city, or a hillside. Alternatively, an external source such as Google Earth maps, Microsoft Virtual Earth maps, or three dimensional renderings provided by city or state planners may be used when responding to emergencies.

One challenge with the increasing amount of digital information that is available today is to enable an end user to quickly digest and understand the information. In the example illustrated in FIG. 2, a mission commander may have dozens of human assets allocated to a selected location. The graphical user interface 200 enables the mission commander or other type of leader to quickly assess the position and health of the human assets that have been allocated to the field based on the icons displayed in the GUI.

Another method of dealing with large amounts of information is through classification and organization of the information. One method that can be used to organize information received from a plurality of deduced reckoning systems 100 is through the use of one or more artificial neural networks. An artificial neural network is a mathematical model or computational model based on biological neural networks. The model consists of an interconnected group of artificial neurons. Information is processed using a connectionist approach to computation.

In most cases, an artificial neural network is an adaptive system that can change its structure based on external or internal information that flows through the network during a learning phase. Artificial neural networks are commonly used to model complex relationships between inputs and outputs or to find patterns in data.

An artificial neural network control system can be applied to the information received from a plurality of deduced reckoning systems 100 (FIG. 1). Each deduced reckoning system can communicate positional and path information, environmental information, health information and so forth. Each data point can be considered a variable. The variables can be continuously gathered from the external transceiver 130 connected to the deduced reckoning system 100, transmitted to the command and control 150 transceiver 154 and communicated to the visualization system 158. This visualization system can include an artificial neural network. The data streams from the external transceiver 130 of each deduced reckoning system can be input into the artificial neural network, where the information can be grouped. Continuous correlation coefficients can be calculated to determine statistical relationships between and within data points and variable groupings. These variable relationships can be dynamically compared to asset control algorithms used to determine command and control inputs and corrective actions to increase asset performance or safety.

Used together, the artificial neural network and the dynamically generated three dimensional software environment, as illustrated in FIG. 2, can be used to create a realistic graphical user interface that is accurate and intuitive. This dynamic portrayal of human assets to a command and control center interface, together with summary and advisory information outputs from the artificial neural network control system, along with a dashboard of substantially real time system variables being experienced by the assets, enables command and control center personnel to make informed asset input decisions which can increase mission deployment efficiency and safety.

As actual deployment data into the neural network increases, the correlation between system variables increases in predictive accuracy along with unique stratification applications. Thus, the deployment model can continuously learn and increase in accuracy of predictive outcomes and behaviors. From this increasing body of data and correlations, more accurate algorithms can be developed for use in future deployments.

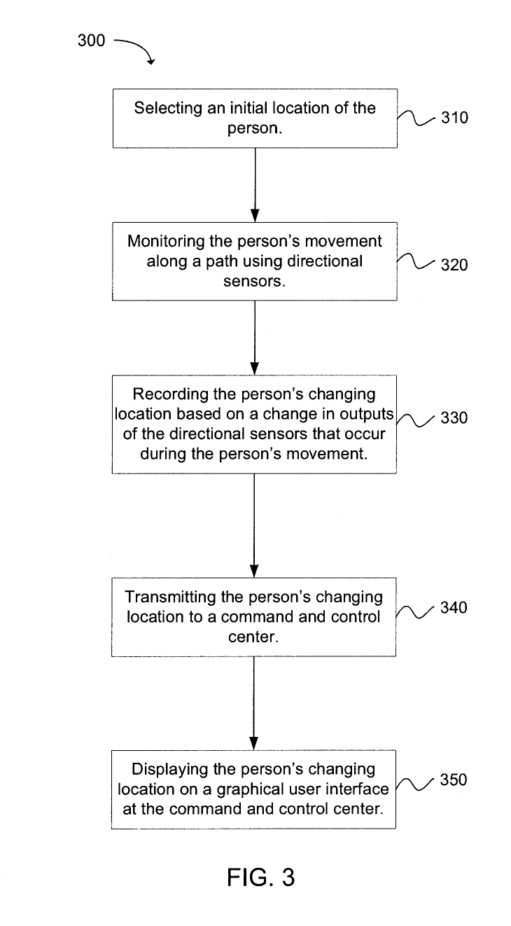

In another embodiment, a method 300 for tracking a person using a deduced reckoning device is disclosed, as depicted in the flow chart of FIG. 3. The method includes the operation of selecting 310 an initial location of the person. The person's movement along a path is monitored 320 using directional sensors. The path is the location along which the person travels and is not intended to infer a predetermined path, but merely the direction of travel of the person. The person's changing location is recorded 330 based on a change in outputs of the directional sensors that occur during the person's movement. The person's changing location is transmitted 340 to a command and control center. The person's changing location is then displayed 350 on a graphical user interface at the command and control center.

The person's movement can be monitored using directional sensors such as a digital magnetic compass, an altimeter, and one or more accelerometers, magnetometers, and gyroscopes. The graphical user interface can also be used to display a person's health status based on health sensors connected to the person and in communication with the deduced reckoning device. In addition, environmental indicators at the person's changing location can be displayed in the graphical user interface based on environmental sensors in communication with the deduced reckoning system.

Data that is received from the deduced reckoning system, such as health data, environmental data, and positional data can be correlated using an artificial neural network to determine a statistical relationship between the variable data. Command and control decisions can be determined based on the correlations to provide a corrective action, as needed.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A deduced reckoning system for tracking a person, comprising:
a deduced reckoning device containing a plurality of directional sensors configured to sense a movement of the person along a path;
a digital processor coupled to the directional sensors and configured to output information to enable a change in position of the deduced reckoning device to be determined based on a change in output from the directional sensors;
a transceiver connector operable to connect to an external transceiver configured to transmit the output information from the digital processor;
a tracking device connector operable to be connect to an external radio frequency tracking receiver configured to receive an approximate location of the deduced reckoning device based on a plurality of radio frequency signals to supplement positional data provided by the plurality of directional sensors; and
an external sensor connector operable to connect at least one external sensor to the deduced reckoning system to enable data collected by the at least one external sensor to be transmitted by the external transceiver.

2. The system of claim 1, wherein the plurality of directional sensors are selected from the group consisting of a digital magnetic compass, at least one accelerometer, at least one magnetometer, at least one gyroscope, and an altimeter.

3. The system of claim 1, wherein the external radio frequency tracking receiver is selected from the group consisting of a global positioning system (GPS) receiver, and a terrestrial based radio frequency triangulation receiver.

4. The system of claim 1, wherein the at least one external sensor is selected from the group consisting of an environmental sensor and a health sensor.

5. A system for tracking a person, comprising:
a deduced reckoning device containing a plurality of directional sensors configured to sense a movement of the person along a path;
a digital processor coupled to the directional sensors and configured to output information to enable a change in position of the deduced reckoning device to be determined based on a change in output from the directional sensors;
a transceiver connector operable to be connected to an external transceiver configured to transmit the output information from the digital processor; and
a graphical user interface configured to display a location of the person based on the output information received from the transceiver.

6. The system of claim 5, wherein the plurality of directional sensors are selected from the group consisting of a digital magnetic compass, at least one accelerometer, at least one magnetometer, at least one gyroscope, and an altimeter.

7. The system of claim 5, further comprising a global positioning satellite (GPS) receiver configured to be connected to the deduced reckoning device.

8. The system of claim 7, wherein the digital processor is further configured to receive positional data of the person from the GPS receiver and integrate the positional data with the location from the deduced reckoning device.

9. The system of claim 5, wherein the graphical user interface displays a three dimensional image of a location in which the person is located.

10. The system of claim 9, wherein the graphical user interface displays an icon representing the person's location in the three dimensional image.

11. The system of claim 10, wherein the icon is selected to represent at least one of the person's team affiliation, the person's health, and an environmental status at the person's location.

12. The system of claim 5, further comprising an external sensor connector operable to connect at least one external sensor to the deduced reckoning device to enable data collected by the at least one external sensor to be transmitted by the external transceiver.

13. The system of claim 5, wherein the at least one external sensor is selected from the group consisting of an environmental sensor and a health sensor.

14. A method for tracking a person using a deduced reckoning device, comprising:
selecting an initial location of the person;
monitoring the person's movement along a path using directional sensors;
recording the person's changing location based on a change in outputs of the directional sensors that occur during the person's movement;
transmitting the person's changing location to a command and control center; and
displaying the person's changing location on a graphical user interface at the command and control center.

15. The method of claim 14, wherein monitoring the person's movement further comprises monitoring the person's movement using directional sensors selected from the group consisting of a digital magnetic compass, at least one accelerometer, at least one magnetometer, at least one gyroscope, and an altimeter.

16. The method of claim 14, further comprising displaying the person's health status based on health sensors connected to the person and in communication with the deduced reckoning device.

17. The method of claim 16, further comprising displaying environmental indicators at the person's changing location based on environmental sensors in communication with the deduced reckoning device.

18. The method of claim 17, further comprising correlating variable data received from the health sensors, the environmental sensors, and the directional sensors using an artificial neural network to determine a statistical relationship between the variable data to determine command and control inputs necessary to provide a corrective action.

19. The method of claim 14, wherein displaying the person's changing location on the graphical user interface further comprises displaying an avatar on the graphical user interface that represents the person.

20. The method of claim 19, further comprising displaying an animated avatar on the graphical user interface, wherein the animation represents information received at the command and control center from at least one of the directional sensors, health sensors, and environmental sensors.
